(19) United States
(12) Patent Application Publication
(10) Pub. No.: US 2009/0040971 A1
(43) Pub. Date: Feb. 12, 2009

(54) Channel selection method for improved wireless communication

(76) Inventors: Jorge Alicot, Davie, FL (US); Ronald F. Devoe, Miami, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 11/918,770

(22) PCT Filed: Feb. 17, 2006
(86) PCT No.: PCT/US2006/007073

§ 371 Date: Jul. 23, 2008

Related U.S. Application Data
(60) Provisional application No. 60/672,353, filed on Apr. 18, 2005.

(51) Int. Cl. H04W 74/00

(52) U.S. Cl. 370/329

(57) ABSTRACT

A communication system (10) receiving a communication signal from a far communication system (12) has a channel selector, and a number of local transceivers (22) forming a first broadcast array and a second channel searching array. The first broadcast array is configured to receive the communication signal and transmit a local communication signal on channels. Each local transceiver is connected to a controller (32). The controller is configured to remove noise from the far communication signal. The noise includes interference from the local transceivers being received on the channel. The controller measures a parameter of at Least one of the channels. The controller determines an availability of one or some channels using the second channel searching array. The second channel searching array outputs an available channel signal to the controller. The controller (32) communicates the availability to at least one of the first broadcast array to transmit and to receive the far communication signal on the available channel.

### CROSS REFERENCE TO RELATED PATENT APPLICATIONS

The instant patent application hereby claims priority to U.S. Provisional Patent Application Ser. No. 60/672,353 filed on Apr. 18, 2005, which is herein incorporated by reference in its entirety.

### BACKGROUND

1. Technical Field

The present disclosure relates to a channel selection method for an improved wireless communication. More particularly, the present disclosure relates to a local wireless communication system and so called “far” communication system with the local wireless communication system discriminating between local signals and far signals for an improved usable channel selection and reduced interference.

2. Background of the Related Art

Common wireless communication systems use transceivers. Transceivers each transmit and receive signals, or are made of a discrete and separate transmitter and receiver. A number of such transceivers may form a wireless local system. A far communication system typically includes a wired network that has a number of base stations. Each base station is typically connected to a controller such that each base station communicates with the local system using a desired wireless channel from a number of available wireless channels. The transceivers also use the desired wireless channel to configure a wireless communication link between the transceivers and the far communication system. A control signal from the controller typically controls a channel selector. The control signal designates a desired channel that is assigned for communication so the base station is able to communicate with each of the transceivers.

One problem noted in the art of wired communications is that when adjacent transceivers use or are assigned a wireless channel by the controller, there may exist an amount of interference between the transceivers. Still further, when there are a number of local communication components transmitting a signal (even on different channels) the proximity may cause interference with transmissions on other channels rendering them virtually unusable. Moreover, depending on the application, there may be specific and stringent rules applicable for the transmission, detection, and interaction of communication sources. This may limit the number of available wireless channels due to the stringent rules and applicable regulations, i.e., the transceiver may be precluded from transmitting or receiving signals on some wireless channels. Accordingly, it is desirable to have a device that can discriminate between local communication devices and far communication devices. It is also desirable to have a device that discriminates from a far source and a local source and that can receive the discriminated signals from each of the sources. It is also desirable to have a device that can make independent channel access decisions. It is further desirable to have a device that selects a wireless channel that has the best opportunity for wireless communication and that minimizes interference between different system equipment. It is further desirable to have a device that selects a wireless channel with the selection having a best opportunity for wireless communication. It would also be desirable to have a communication system that emits a trigger signal when a usable channel is determined to better coordinate with the local communication components.

### SUMMARY

It is an object of the present disclosure to provide a communication system that can distinguish from a local communication signal and a far communication signal to reduce interference on the far communication signal from the local communication signal.

It is an object of the present disclosure to provide a communication system that has a number of transceivers that can search for an available channel and also control another number of transceivers to communicate with a far communication source on that usable channel.

It is another object of the present disclosure to provide a communication system that has a number of transceivers that can search for an available usable channel and can broadcast the available channel to other transceivers on another master channel.

It is still another object of the present disclosure to provide for a communication system for use with an electronic article surveillance system that has a number of transceivers that can search for an available channel and broadcast the available channel to other transceivers using a communication link with each of the transceivers located closely adjacent to one another.

According to a first aspect of the present disclosure, there is provided a channel selection method having an improved wireless communication between a first local communication system and a second far communication system. The method has the steps of coordinating a plurality of local transmitters in a listening mode for a remote wireless signal across a plurality of channels and determining a usable channel configured to transmit from the plurality of channels by distinguishing between a signal from the first local communication system and a signal from the second far communication system. The method then has the step of transmitting on the usable channel.

According to another aspect of the present disclosure, there is provided a channel selection method having an improved wireless communication between a first local communication system emitting a modulating signal and a second far communication system emitting a substantially constant signal. The method has the steps of coordinating a plurality of local transceivers in a receiving mode configured to receive a remote wireless signal across a plurality of channels and determining a usable channel to transmit. The usable channel is derived from the plurality of channels. The usable channel is iteratively determined by distinguishing between a parameter of the modulating signal and the substantially constant signal on at least one channel. The modulating signal modulates to zero during a cycle to remove it from the channel as noise. The method has the step of transmitting on the usable channel.

According to yet another aspect of the present disclosure, there is provided a communication system to receive a communication signal from a far communication system. The communication system has a channel selector and a plurality of local transceivers configured to receive the communication signal and transmit a local communication signal on a plurality of channels. Each of the plurality of local transceivers is connected to a controller. The controller is configured to remove noise from the far communication signal. The noise may include an amount of interference from the plurality of local transceivers received on the channel. The controller measures a parameter of at least one of the channels. The controller determines an availability of at least one channel of the channels. The controller communicates the availability to at least one of the plurality of transceivers to transmit and/or receive the communication signal.

According to still yet another aspect of the present disclosure, there is provided a communication system for receiving a communication signal from a far communication system. The system has a channel selector, and a plurality of local transceivers forming a first broadcast array and a second channel searching array. The first broadcast array is configured to receive the communication signal and transmit a local communication signal on a plurality of channels. Each local transceiver is connected to a controller.

The controller is configured to remove noise from the far communication signal. The noise may be interference from the plurality of local transceivers received on the channel. The controller measures a parameter of at least one of the plurality of channels. The controller determines an availability of at least one channel of the channels using the second channel searching array. The second channel searching array outputs an available channel signal to the controller. The controller communicates the availability to at least one of the first broadcast array to receive the far communication signal on the available channel.

### DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a schematic simplified diagram of a far communication system communicating signals to a local communication system;

FIG. 2 is another schematic diagram of a transceiver of the local communication system of FIG. 1;

FIG. 3 is another schematic diagram of the local communication system of FIG. 1;

FIG. 4 is a flow chart illustrating one algorithm for use with the local communication system.

FIG. 5 is a plot showing voltage per unit time of the far communication signal and a local communication signal both received by the local communication system of FIG. 1.

FIG. 6 is a flow chart illustrating another algorithm for using with the local communication system.

FIG. 7 is another schematic diagram of the local communication system having an array of transceivers.

FIG. 8 is another schematic diagram of the local communication system having an array of transceivers and a trigger communication component.

FIG. 9 is a flow chart illustrating another algorithm for use with the local communication system.

### DETAILED DESCRIPTION OF THE EMBODIMENTS

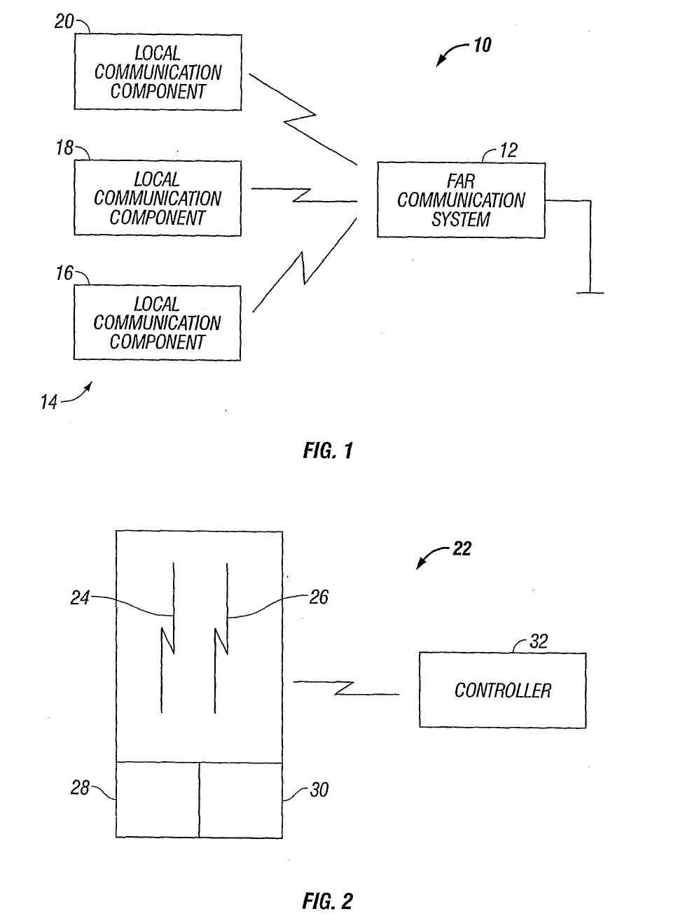

Referring now to FIG. 1, there is shown a block diagram of a wireless communication system 10. The wireless communication system 10 may be any communication system in the art that can communicate data or signals from one location to another location in a wireless manner. In one embodiment of the present disclosure, the wireless communication system 10 may be used in connection with an electronic article surveillance (EAS) system, a LAN network, a telecommunication or mobile phone network, a radio network, or any other wired communication system known in the art. The system 10 also has a far communication source or system 12. The far communication system 12 may be any communication system that is located a predetermined distance away (such as a few feet or a mile) and that transmits a wireless signal to be received by another system. In one embodiment, the far communication system 12 is a base station connected to a wired network. The far communication system 12 transmits and receives a communication signal.

The signal may be a radio-frequency signal, a digital signal, an encoded signal, a magnetic field, a microwave signal or any other digital signal, digital packet or analog signal known in the art for communication between the far communication system 12 and another second communication system. Each base station of the far communication system 12 has components such as a channel selector (not shown), a memory, and a controller to communicate with a local communication system 14 having a number of local components 16, 18, and 20 over a desired wireless channel. In one embodiment, the number of local communication components of the local communication system 14 may be a first local component 16, a second local component 18, a third local component 20 or any number of local components. Each independently or collectively can communicate with the far communication system 12.

Alternatively, the wireless communication system 10 may have the far communication system 12 with a number of base stations depending on the wireless communication application. These components may communicate with one or more other wired or wireless communication systems that may include one or more other transmitters, a LAN network, one or more servers, one or more computers, hosts, receivers, transceivers, or a number of other mobile stations. The wireless communication system 10 may communicate using a single wireless channel, Ch. 1, for example, or it may communicate using multiple wireless channels, Ch. 2, or Ch. 3 with another wireless communication system. Still alternatively, the wireless communication system 10 may further include the far communication system 12 having the base station sharing one or more channels when there are no unused wireless channels.

The communication system 10, in one embodiment, has the far communication system 12 communicating with each component of the local communication system 14. In one embodiment, each of the components of the local communication system 14 may be a wireless transceiver. Alternatively, the local communication system 14 may include local communication components such as a number of transmitters and a number of receivers. Various other configurations are possible and within the scope of the present disclosure.

Referring now to FIG. 2, there is shown a schematic view of a wireless transceiver 22 of the local communication component 16. Each transceiver 22 of the local communication system 14 has a transmitting antenna or coil 24, a receiving antenna or coil 26, a field generator 28, and a receiver 30.

Each transmitting antenna or coil 24 is operable to transmit a signal or data to another of the local transmitting components 18, and 20 of the local communication system 14 or to the far communication system 12. The field generator 28 is operatively connected to the transmitting antenna or coil 24. In response to a control signal from a controller 32, the field generator 28 will supply a predetermined amount of electrical current to the transmitting antenna or coil 24. The electrical current is in the form of an alternating current drive signal. The alternating current drive signal has a frequency component and is sufficient to transmit a signal to another local communication component 18, 16 of the local communication system 14, or alternatively to the far communication system 12 or still further to another base station that is wired to the far communication component 14. Various combinations are possible and within the scope of the present disclosure.

The receiving antenna or coil 26 is operatively connected to the receiver 30 and is capable of receiving and detecting a signal. The receiver 30 is capable of extracting signal information from the local communication component 18, 20 of the local communication system 14, the far communication component 12, another base station, or another analog or digital source. The receiver 30 then provides an appropriate input signal to the controller 32 for further processing.

Referring now to FIGS. 1 through 3, there is shown a schematic diagram showing a number of components of the local communication system 14. In this embodiment, the local communication system 14 has two local communication components 16, and 18 which are configured as two transceivers 22, 34 however, the local communication system 14 may have any number of local communication components. The local communication system 14 has the controller 32 which is operatively connected to transceivers 22, 34 of the local communication system 14. The controller 32 sends or receives data from each of the field generators 28 and each of the receivers 30 in transceivers 22, 34. The controller 32 may be connected thereto by a cable or in any other suitably wired or wireless manner. The data connection between the controller 32 and each of the transceivers 22, 34 of the local communication system 14 may also be a wireless communication link to enable the controller 32 to receive signal information from each receiver 30 of the transceivers 22, 34 of the local communication system 14 as previously discussed.

The controller 32 is further configured to analyze the signal information received by the transceivers 22, 34 (or one or more other local communication components) using a number of program instructions, and processing algorithms to determine whether valid or corrupt data has been received and process the same. The controller 32, in response to received valid data, sends an appropriate control signal to each of the transmitter antennas or coils 24 in transceivers 22, 34 using the field generator 28 as shown in FIG. 2. The control signals may instruct the field generator 28 to increase electrical current, decrease, electrical current, or maintain constant the electrical current that is supplied to the transmitting antenna coil 24 in the transceiver 22 or any number of transceivers 22, 34 of the local communication system 14. In one exemplary example, the controller 32 sends a first control signal to a first field generator 28 to increase current in the first transceiver 22 and to the transmitting antenna 24. Simultaneously, the controller 32 sends another or second control signal to another second field generator (not shown) of the second transceiver 34 to decrease the current to the transmitting antenna in an inversely proportional relationship relative to the transceiver 22. Various other combinations are possible and within the scope of the present disclosure to permit the local communication system 14 to communicate with the far communication system 12.

In operation, each wireless transceiver 22, 34 of the local communication system 14 will search for a transmission channel. The search is typically performed in a number of passes using a number of wireless transmission channels such as, in one example, 64 channels. In operation, each wireless transceiver 22, 34 of the local communication system 14 selects the wireless channel to communicate with the far communication system 12.

One problem known in the art is that often each wireless transceiver 22, 34 (depending on a given application) may be restricted to one or more channels due to regulatory concerns. This restriction is limiting on the system since the transceivers 22, 34 cannot use, for example, all of the possible available channels. Moreover, due to the arrangement of some local communication systems each of the wireless transceivers 22, 34 may be located in a similar confined arrangement or in proximity to one another. This potential close spacing relative to one another may cause interference between one or more transceivers transmitting and receiving signals. The presently disclosed design of the local communication system 14 remedies this problem as explained in more detail below.

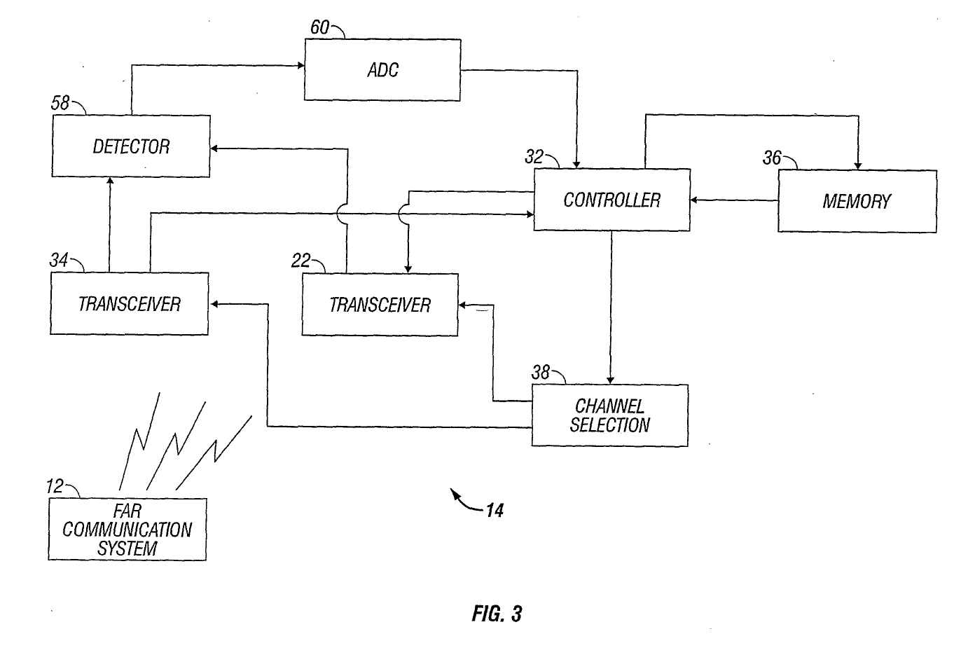

FIG. 3 shows the communication system 10 with the transceiver 22 connected to the controller 32 and the controller 32 connected to a storage medium or memory 36. The storage medium or memory 36 further has a stored predetermined amount of data and program instructions and the controller 32 has the ability to write to the storage medium 36 to store another predetermined amount of data. The controller 32 is connected to a channel selector 38. The channel selector 38 is operatively controlled by the controller 32. The channel selector 38 can select from one or more wireless channels that the local communication system 14 is permitted to transmit and to receive data (due to the applicable regulatory structure) using a control signal from the controller 32.

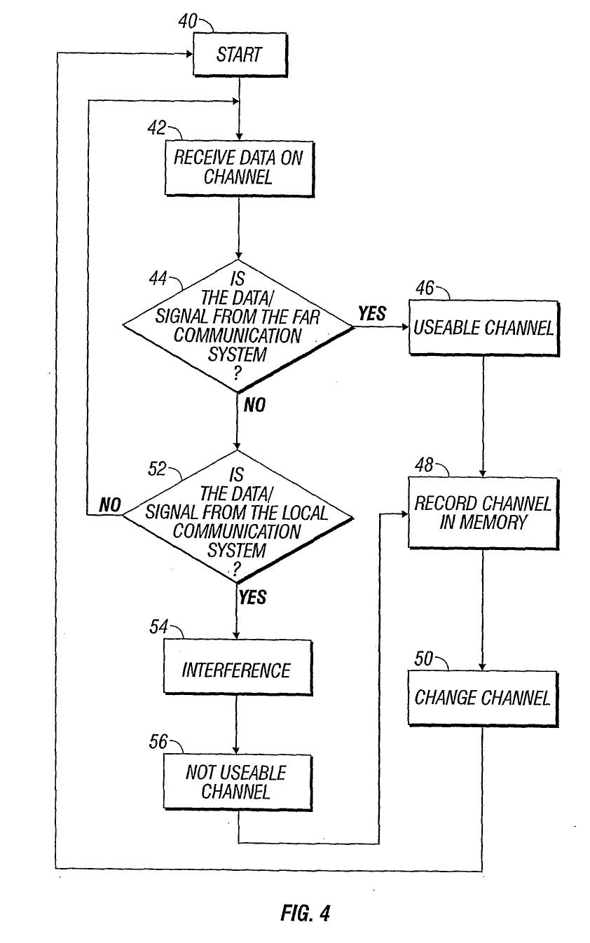

Each of the transceivers 22, 34 of the local communication system 14 has the ability to determine if the source of the signal received is from another local transmitting communication component or the far communication system 12. Referring now to FIG. 4, there is shown a flow chart showing the operation of the local communication system 14 herein. Referring now to the commencement of operation at step 40, the control passes to step 42 where the local communication system 14 receives data on a channel such as a first channel, or Ch.1. The local communication system 14 has the potential to distinguish between signals from the far communications system 12 and the local communication system 14. Once data is received, control passes to a decision block at step 44. In step 44, the controller 32 is configured to analyze the signal that the receiver antenna detects, and the receiver receives. Using the signal, the controller 32 determines whether the data/signal received is from the far communication system 12. If the system 10 does indeed receive a signal from the far communication system 12 control passes to step 46.

At step 46, the controller 32 indicates that a usable channel has been found for communication and at step 48, the controller 32 writes/records the usable channel to the memory 36. Control passes to step 50, where the channel selector 38 changes the channel to the usable channel for communication and thereafter other components can search for other usable channels. At step 50, the controller 32 outputs a control signal to the channel selector. The controller 32 changes to the next channel in sequential fashion, Ch. 2 or a random channel, (such as Ch. 64) and control passes back to step 42 and data is received on the next channel for the next cycle.

At step 44, if the local communication system 14 does not receive a signal from the far communication system 14 control passes to another decision block at step 52. At step 52, the controller 32 determines whether the signal is received from the local communication system 14 (if any) on the same channel as the data from the far communication source 12 is in the form of, for example, interference, a corrupted or a mixed signal.

Near or local RF sources (emitted from one of the transmit antennas of the local communication system 14) can overpower a signal from the far communication system 12 or source on the same channel and may cause interference. If a positive determination is reached at step 52, then control passes to step 54. At step 54, the controller 32 determines that this is an unusable channel and/or there is interference on the channel, and the controller 32 will write to memory 36 that the channel is not usable and will record that unusable channel in memory at steps 56 and 48. Thereafter, the channel will be changed by the channel selector 38 to the next channel and control will pass to step 42, for the next cycle.

Referring again back to FIG. 3, each of the transceivers 22, 34 of the local communication system 14 is operatively connected to a detector 58. The detector 58 detects one or more parameters of the local transceivers 22, 34 or transmitting components of the transceivers 22, 34 and outputs the detected one or more parameters to the controller 32. Detector 58 is operatively connected to the controller 32 by a suitable analog to digital converter 60. The controller 32 using the detector 58 determines if the source of a signal is received from the local transmitting components such as transceivers 22, 34 or the far communication system 12 on each channel. The controller 32 then controls one or more transceivers 22, 34 of the local communication system 14 to transmit on this selected usable channel to reduce interference and to provide for a clearer signal to and from the far communication component 14.

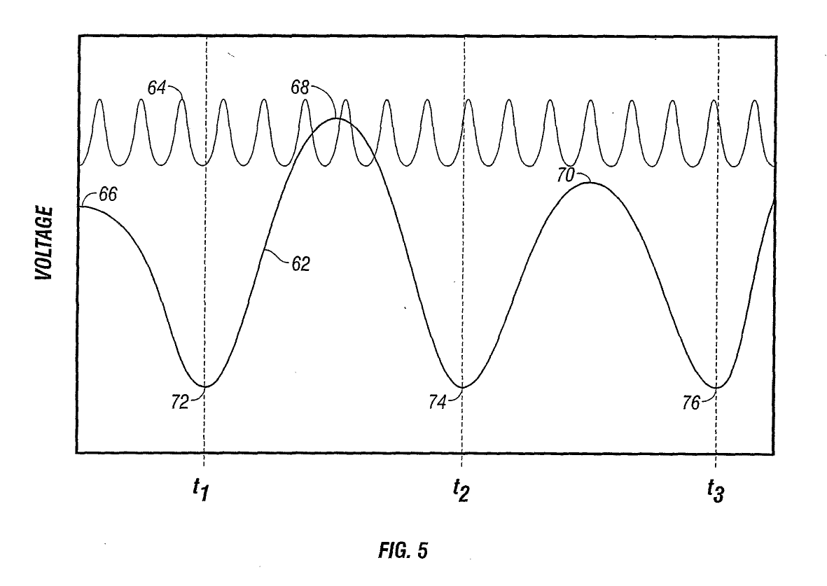

FIG. 5 shows a plot of a detected parameter received by either the transceiver 22 or the transceiver 34 or another transceiver/local communication component and that is operatively connected to the detector 58. In one embodiment, the parameter is a voltage of the signal received by the transceiver 22, 34 per unit time. As can be understood from FIG. 5, it is understood that the signals received from the local communication system 14 modulates more per unit time than signals that are received from the far communication system 12.

Referring now to the plot shown in FIG. 5 of voltage per unit time, there is shown a first signal 62 from the local communication system 14 and a second signal 64 received from the far communication system 12. As can be understood from the figure, the first signal 62 modulates greatly relative to the second signal 64. It has been observed that the second signal 64 from the far communication system 12 does not substantially modulate in voltage per unit time relative to another first signal 62 from the local communication system 14. One skilled in the art should appreciate that the detected parameter in this embodiment is a voltage per unit time, but it is not limiting. The detected parameter may be any parameter that can be detected by the local communication system 12 such as signal duration, signal phase, a signal fall time, a signal rise time, a current per unit time, a magnetic flux, or a combination of parameters. The detector 58 of FIG. 4 may further have a discrete voltage detector that is operatively connected to one or both of the first and second transceivers 22, 34. Detector may monitor a power modulation of each transceiver independent of the signal received by the transceivers 22, 34 as a reference. The detector may use these readings as a control group in order to assist with a determination which of the signals 62, 64 of FIG. 5 on each selected channel belongs to the local communication source 14 and which belongs to the far communication source 12.

The first signal 62 is in sinusoidal form and has a first peak voltage reading 66, a second peak voltage reading 68, and a third peak voltage reading 70. These may be averaged or only the highest reading of the first peak voltage reading 66, the second peak voltage reading 68, and the third peak voltage 70 reading may be used. The first signal 62 may be thus identified by the modulation and the peak voltage readings 66, 68, and 70 as a local equipment power level. The controller 32 will thus attribute this first signal 62 as a signal received from the local communication system 14 based on a peak voltage level.

The first signal 62 also has a first voltage point 72, a second voltage point 74, and a third voltage point 76 that may be recorded. The reading at these voltage points 72, 74, and 76 establishes a signal floor of the first signal 62. Thus, the second signal 64 is thus identified at the time “(t) 1” by the first voltage point 72 or another low voltage point 74, 76. The detector 58 detects or samples a highest voltage reading and a lowest voltage reading per unit time. Thus, a channel peak power level identifies and is indicative of the first signal 62 of local communication source 14 and the minimum voltage level at “(t)1” identifies the second signal 64 or a far RF signal source for each wireless channel. In this manner, the detector 58 outputs the readings to the controller 32 and the controller 32 can make a determination of the availability of the wireless channel. If multiple signals are received, the controller 32 may simply assume that the channel is unavailable and not suitable for transmission.

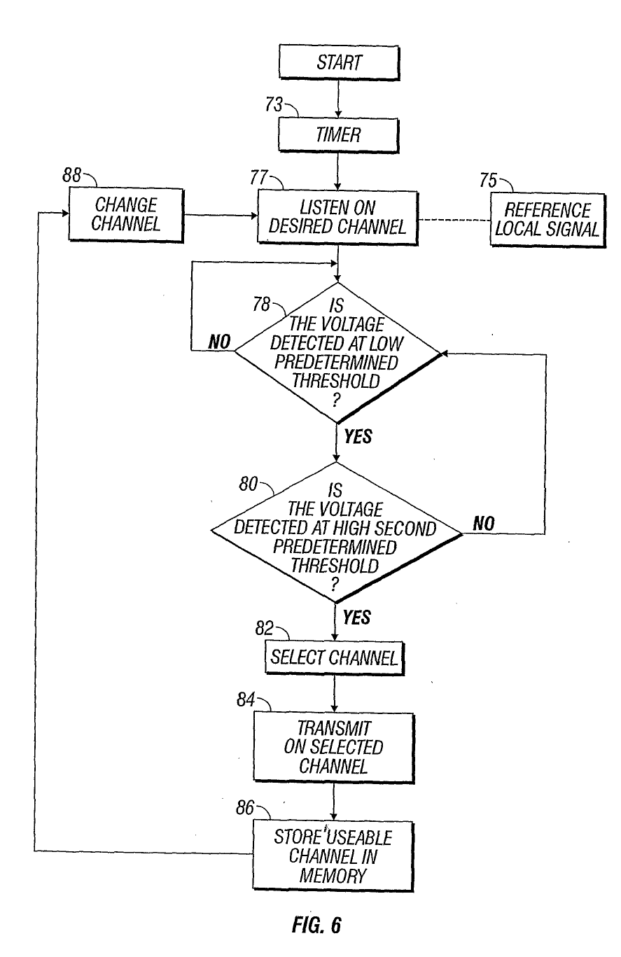

FIG. 6 shows another flowchart or algorithm illustrating a number of general program instructions for the controller 32 for controlling each local transceiver 22, 34 of the local communication system 14. The transceivers 22, 34 will listen on a particular channel at step 77 at a particular time using a time window assigned by timer at step 73. Then control will pass to a decision block 78. As described above, the signal from the local communication source 14 will deeply modulate over time relative to the signal from the far communication system 12 that remains constant in comparison. The controller 32 may access a reference signal or reference data stored in the memory 36 at step 75 to compare the signal received by each transceiver 22, 34 at the channel. At decision block 78, at this particular channel and time window, the controller 32 will determine whether the received parameter on the channel is at a low predetermined threshold to determine whether the signal is the signal floor. If the signal is at the low threshold and the signal floor is established then control passes to decision block 80. If the received signal is not at the lowest predetermined threshold and it is determined that the signal is not the signal floor, then control will pass back to step 77. At step 77, the local communication system 14 will continue to listen on the desired channel at another time window.

At the decision block 78, if the controller 32 determines that the received parameter, (i.e., the voltage reading at the time) is indeed at the lowest predetermined threshold, the controller 32 assumes that the received signal is at the signal floor. Control then passes to decision block 80 and another determination is reached. At decision block 80, a determination is made whether the parameter received on the channel detected is at a high predetermined threshold to indicate whether the signal is the distant signal from the far communication system 12. If an affirmative is reached at the decision step 80, control passes to step 82. At step 82, the controller 32 assumes that a usable channel is found and the channel is selected for transmission. If a negative determination is made, then control passes to decision block 78.

Once the operation reaches step 84, the controller 32 assumes that the received signal is indeed from the far communication source 12 and does not have interference from the local communication system 14. Alternatively, the controller 32 may perform processing on the signal to refine the signal or assume that there is little interference and this is an acceptable channel to transmit. If this is an acceptable channel, the controller 32 will output and write selected data to memory 36 for future use and assume that this is a usable channel and an available channel at step 86. Thereafter, at step 88, the controller 32 will control the channel selector 38 to change the channel to another channel and the control will pass to step 77 to listen at another desired time and the cycle repeats for further searching.

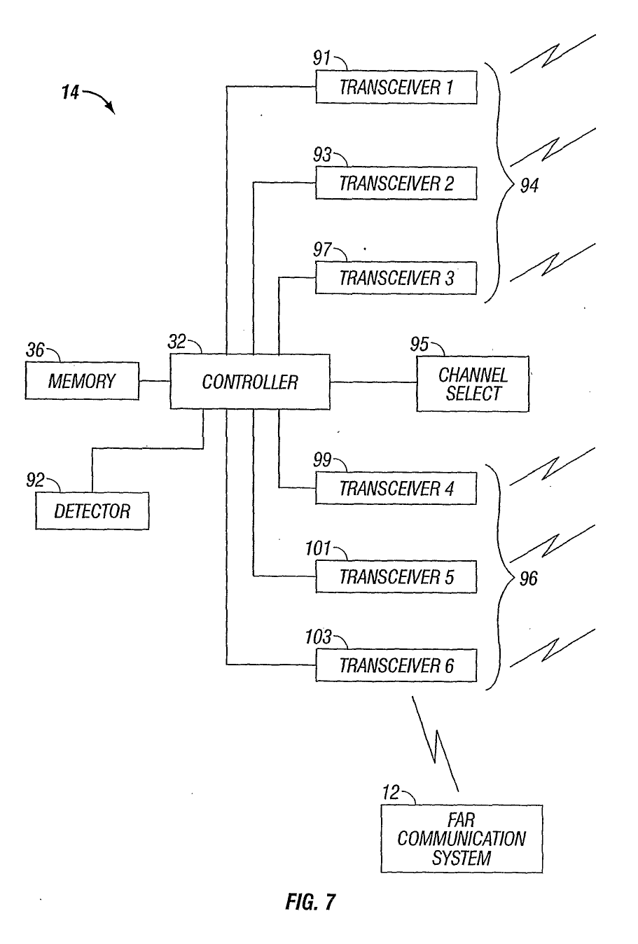

Referring now to FIG. 7, there is shown a schematic of a number of transceivers 91, 93, 97, 99, 101, and 103 of the local communication system 14. In one embodiment, the controller 32 is operatively connected to each of the transceivers 91, 93, 97, 99, 101, and 103 and controls the transceivers to coordinate with one another. In one embodiment, the controller 32 controls a listen time of all or some of the transceivers 91, 93, 97, 99, 101, and 103. In this embodiment, the controller 32 controls all of the transceivers 91, 93, 97, 99, 101, and 103 to listen for a radio frequency signal from the far communication system 12 on different wireless channels during one predetermined time period.

The controller 32 then determines from the detector 92 which of the channels is usable and then controls the channel selector 94 to change each of the transceivers 91, 93, 97, 99, 101, and 103 to communication on that selected usable channel, or search on other channels for another usable channel. Thereafter, each of the transceivers 91, 93, 97, 99, 101, and 103 may transmit/receive on the found usable channel(s).

The controller 32 selectively controls the amount of listening time for a number of listening windows or vary the amount of time. For example, some of the transceivers 91, 93, 97, 99, 101, and 103 may be dedicated to searching for usable channels and some may be dedicated for communication. In another example, all of the transceivers 91, 93, 97, 99, 101, and 103 may be coordinated to search during predetermined time intervals while at other times may be coordinated for communication. Various combinations are possible and within the scope of the present disclosure.

Referring still to FIG. 7, the controller 32 may be connected to a first array 94 of transceivers 91, 93, and 97 and a second array 96 of transceivers 99, 101, 103. Each of the first array 94 and the second array 96 can independently or collectively perform channel searching, transmit and receive functions. In one embodiment, the controller 32 outputs a control signal and is operatively connected to each transceiver 91, 93, and 97 of the first array 94 and to each transceiver 99, 101, and 103 the second array 96. The control signal controls the first array 94 to continuously or periodically use listening periods to execute a channel selection search and output the results to the controller 32. The controller 32 in response thereto records the output results in the memory 36. The controller 32 then accesses the output stored in memory 36 at a later time to determine which selected channels are usable and which channels have a substantial amount of interference from the local communication system 14. Thereafter, after a period of time, the controller 32 controls the channel selector 95 for modulating each or some of the first and the second array 94, 96 to change to the usable channel for communication with the far communication source 12.

The controller 32 then controls the first array 94 or the second array 96 to initiate and conduct the channel selection search. A significant aspect of the local communication system 14 is that the local communication system does not need to synchronize operation or the receive time and transmit time of each of the transceivers 91, 93, 97, 99, 101, and 103 of the first array and/or the second array 96. The receive time for each of the transceivers 90 can be varied or be predetermined by the controller 32.

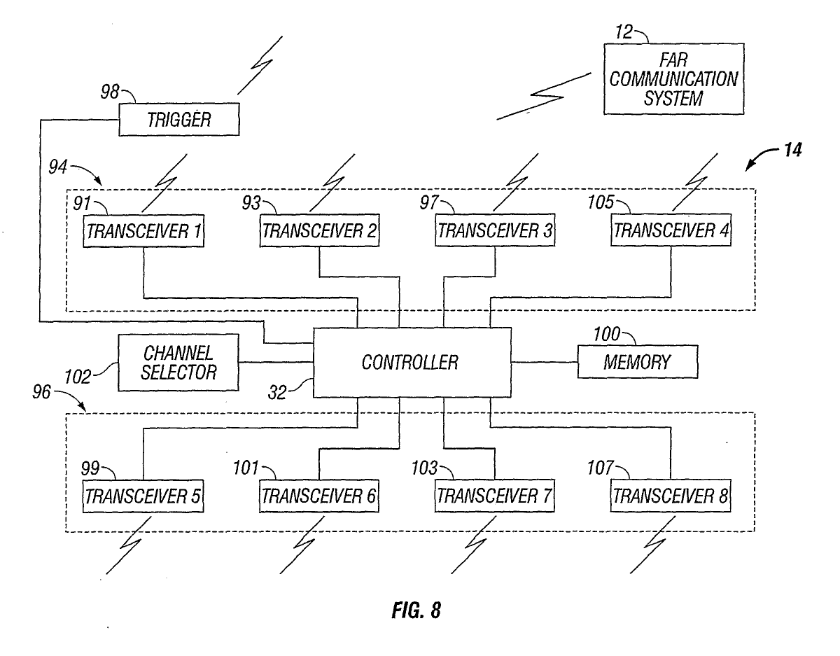

FIG. 8 shows an alternative embodiment of the local communication system 14. In this embodiment, the first array 94 has four transceivers 91, 93, 97, and 105 and the second array 96 also has four transceivers 99, 101, 103, and 107. Various transceiver configurations are possible and the system 14 may have arrays with various numbers of transceivers and any number is within the scope of the present disclosure. In this embodiment, the channel selection search may be initiated by a trigger condition from a central point 98. The trigger condition may include an output signal from the central point 98 once a usable channel is determined. This signal is received by the controller 32, and controller controls one or more components of the local communication system 14 in response thereto. The trigger condition may be a central location or one central transceiver 98 that is not in the first array 92 and the second array 96. The central transceiver 98 receives an amount of information about a channel and then outputs data to the controller 32. The controller 32 in response to the predetermined output data or trigger may then control the channel selector 100 and modulate the channel selection of one or more transceivers 91, 93, 97, 105 of the first array 94 and/or one or more transceivers 99, 101, 103, and 107 of the second array 96 to transmit or receive on the usable channel without interference. In another embodiment, the trigger may be output from another device or from one of the transceivers 91, 93, 97, 105, of the first array 94 and/or from one of the transceivers 99, 101, 103 and 107 of second array 96. Alternatively, the trigger signal may be output from a software algorithm that outputs the signal upon the occurrence of one or more predetermined conditions. Various combinations are possible and within the scope of the present disclosure.

The data output may trigger the controller 32 to execute program instructions to control the first array 94 and/or the second array 96 to run a search algorithm to identify channels to determine availability of the channel and output the results to the controller 32. Once a suitable usable channel is found, the controller 32 can control the first array 94 and/or the second array 96 or at least one transceiver 91, 93, 97, 105, 99, 101, 103, and 107 to communicate, transmit and receive using the relevant usable channel, search some other channels for another usable channel, or simply control some of the first array 94 or the second array 96 to not search for already determined usable channels. A transport to transfer the output data to the controller 32 from the central point 98 or transceiver may be a wired synchronization signal, a local system component, a wired or wireless communication structure or an Ethernet network structure. The controller 32 is then configured upon receiving the data to control the channel selector 102 to switch a channel from a remainder of the first array 94 and/or the second array 96 and to the desired channel.

Alternatively, a channel selection search may be initiated by a trigger condition from a point that is not the central point 98. The trigger condition may be output from another transceiver 91, 93, 97, 105 in the first array 94 or another transceiver 99, 101, 103 and 107 of the second array 96. The trigger signal is received by the controller 32. The trigger condition may be a predetermined amount of data, a measured parameter, or signal that is relevant to a channel to determine an amount of interference. The trigger condition or signal is then output as data to the controller 32 using an analog-to-digital converter (not shown). The controller 32 in response to the output data or trigger may then control the channel selector 102 and modulate the channel selection of one or more transceivers 91, 93, 97, 105 of the first array 94 and/or one or more transceivers 99, 101, 103 and 107 of the second array 96 to coordinate listening. The controller 32 may control the first array 94 and/or the second array 96 to listen for another usable channel, or transmit and receive on the usable channel. The controller 32 then is configured to switch the channel from a remainder of the first array 94 and/or the second array 96 to continue searching.

In another embodiment, the controller 32 controls the channel selector 102 to switch the channel to a usable channel at a predetermined time interval based on a time that is stored in the memory 100.

In yet another embodiment, the controller 32 coordinates operation of the one or more transceivers 90 in the first array 94 and the second array 96 by outputting a control signal that is based on a predetermined time slot. The controller 32 may output the control signal so each of the transceivers 91, 93, 97, and 105 of the first array 94 and/or each of the transceivers 99, 101, 103, and 107 of the second array 96 listen during the predetermined time slot to coordinate a listen channel search operation such as every 10 seconds. The controller 32 may determine at least one usable channel and at least one unusable channel and then output another control signal so some of the first array 94 and the second array 96 transmit and/or receive on the usable channel. The controller 32 can then vary the amount of time for the predetermined time slot depending on the application and store the data to memory 100 to determine a number of usable channels for later transmission. The controller 32 can control some transceivers 91, 93, 97, and 105 for searching functions to listen for one or more usable channels and then control other transceivers 99, 101, 103, and 107 in the second array 96 for transmission and receiving on the usable channel.

In still another embodiment, the controller 32 may be connected to an external input output device to initiate transmission, receiving and searching functions and may use one assigned master communication channel to wirelessly coordinate operation of each of the transceivers 91, 93, 97, and 105 of the first array 94 and each of the transceivers 99, 101, 103, and 107 of the second array 96. Each transceiver 91, 93, 97, 105, 99, 101, 103, and 107 may listen on the selected master communication channel to coordinate the first array 94 and the second array 96. The controller 32 may then selectively designate one transceiver 98 as the coordination point to coordinate operation thereof and broadcast on the mater communication channel. Thereafter, using the data stored in the memory 100, the controller 32 can control the channel selector 102 to control some of the transceivers 91, 93, 97, 105, 99, 101, 103, and 107 and modulate the channel from the current channel to the determined usable channel, and then transmit and receive on the usable channel.

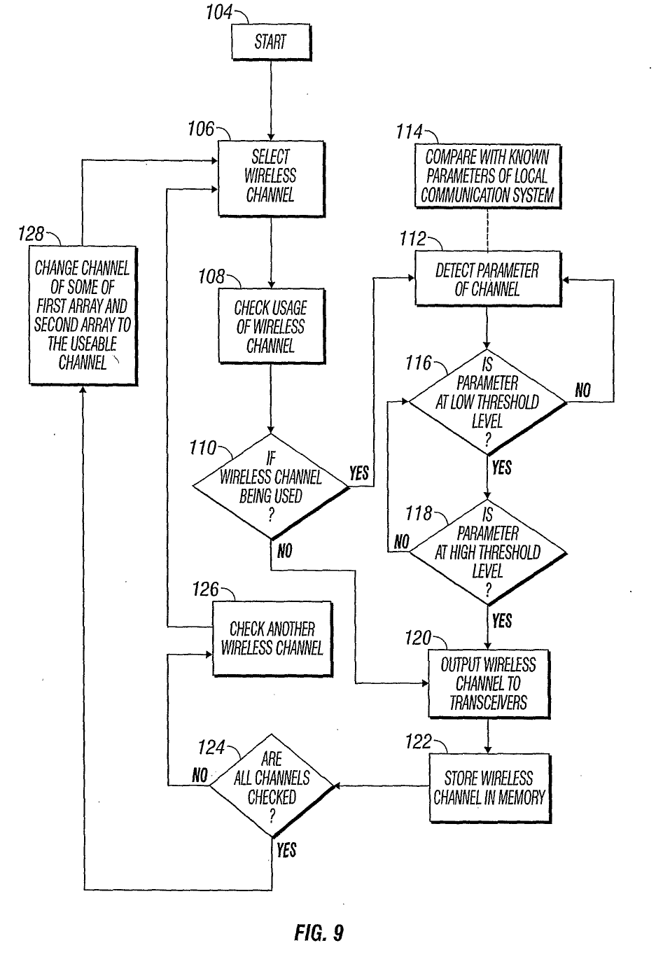

FIG. 9 shows another flow chart for an embodiment of operation of the controller 32 for conducting a channel search operation. The flowchart commences at step 104. At step 106, the controller 32 controls the channel selector 106 (shown in FIG. 8) to change at least one transceiver 91, 93, 97, 105, 99, 101, 103, and 107 to a first wireless channel. The first wireless channel may be a random channel or any desired channel to commence operation of the local communication system 14. The controller 32 will then proceed to step 108 to determine whether the wireless channel is used and proceed to a decision block at step 110. At step 110, if the wireless channel is not used and is available for transmission and receiving functions for the local communication system, then operation will pass to step 120.

If the wireless channel is used, control will pass to step 112 to determine whether there is any interference on the selected channel and the local communication system 14 will discriminate between the signal from the local communication system 14 or whether the signal is from the far communication system 12. The controller at step 112 will detect a parameter of signal of the channel over time. The parameter may be a voltage, or a voltage per unit time, however, one skilled in the art should appreciate that the parameter may be any parameter that can be detected by the communication system 14 such as signal duration, signal phase, a signal fall time, a signal rise time, a current or a combination of parameters.

The parameter is compared by the controller 32 with a known parameter of the local communication system at step 114. Control then passes to a decision block at step 116. At step 116 if the parameter is at a low threshold level, the controller 32 assumes that a noise floor is established and control passes to step 118. If the parameter is not at a tow threshold level, the controller 32 assumes that the noise floor is not yet established and control passes to step 112 to detect the parameter at this later time.

At step 118, another decision is reached and the controller 32 determines whether the parameter is at the high threshold level that is indicative of a signal received from the far communication source 12. If an affirmative determination is reached at step 118, the controller 32 assumes that this channel has identified the signal from the far communication source 12 and control will pass to step 120. If a negative determination is reached at step 118, the controller 32 assumes that this channel has not received the signal from the far communication source 12 and control will pass to step 116.

The controller 32 at step 120 will output the identified channel to other transceivers of the first array 94 and/or the second array 96 and the controller 32 will write the usable channel to memory 100 at step 122. Thereafter, the control will pass to step 124 to a determination block. At the determination block 124, the controller 32 will determine whether all of the channels have been checked. If not all of the wireless channels that are available have been checked, then control will pass to step 126. At step 126, the controller 32 will control the channel selector 102 to change the channel to check another wireless channel for further searching. Control will then pass to step 106. At step 124, if all of the channels have been indeed checked, control then passes to step 128.

At step 128, the controller 32 will output a control signal and change some of the transceivers to usable channels for transmit and receive functions, and the controller 32 may also further control other transceivers to continue the searching for later times and control will pass to step 104.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods and techniques that are insubstantially different from those described above and/or in the appended claims are also intended to be within the scope of the disclosure.

What is claimed is:

1. A channel selection method for an improved wireless communication between a first local communication system and a second far communication system, the method comprising:
coordinating a plurality of local transmitters in a listening mode in connection with a remote wireless signal across a plurality of channels;
determining a usable channel configured to transmit from said plurality of channels by distinguishing between a signal from the first local communication system and a signal from the second far communication system;
transmitting on said usable channel.

2. The method according to claim 1, wherein said usable channel is determined by listening for said remote wireless signal and substantially ignoring interference from said first local communication system.

3. The method according to claim 1, wherein said usable channel is determined by listening for said remote wireless signal by listening at a point when a local signal from said first local communication modulates to a lowest level.

4. The method according to claim 3, wherein said lowest level is determined when said first local communication system signal modulates from a peak voltage level to a substantially off voltage level, and wherein said usable channel is determined by listening for said remote wireless signal by listening at said substantially off power level.

5. The method according to claim 1, wherein said usable channel is determined by detecting a highest voltage sample and a lowest voltage sample from at least one channel from said plurality of channels, and wherein said usable channel is determined therefrom.

6. The method according to claim 1, wherein the determining step measures both a peak radiofrequency power level and a minimum radiofrequency power level.

7. The method according to claim 6, wherein the determining step measures a parameter selected from the group consisting of a signal duration, a signal phase, a signal rise time, and a signal fall time, and any combinations thereof from both said peak radiofrequency power level signal and said minimum radiofrequency power level signal.

8. The method according to claim 1, wherein the coordination step includes steps of coordinating a plurality of local transmitters listening for a remote wireless signal across a plurality of channels and outputting a result to a data table, and accessing said data table for transmitting on said usable channel.

9. A channel selection method for an improved wireless communication between a first local communication system emitting a modulating signal and a second far communication system emitting a substantially constant signal relative to said modulating signal, the method comprising:
coordinating a plurality of local transceivers in a receiving mode configured to receive a remote wireless signal across a plurality of channels;
determining a usable channel for transmission, said usable channel being derived from said plurality of channels, wherein said usable channel is iteratively determined by distinguishing between a parameter of said modulating signal and said substantially constant signal on at least one channel, wherein when said modulating signal modulates to zero during a cycle said modulating signal is removed from said channel as interference; and
transmitting on said usable channel.

10. The channel selection method according to claim 9, wherein said parameter is selected from the group consisting of a voltage, a voltage per unit time, a signal duration, a signal phase, a signal rise time, and a signal fall time.

11. The channel selection method according to claim 10, wherein both a peak and a base of said voltage signal is received per unit time to distinguish between said parameter of said modulating signal and said substantially constant signal.

12. A communication system receiving a communication signal from a far communication system, the communication system comprising:
a channel selector;
a plurality of local transceivers configured to receive said communication signal and transmit a local communication signal on a plurality of channels, wherein each of said plurality of local transceivers are connected to a controller, said controller configured to remove an amount of interference from said plurality of local transceivers being received on said channel;
wherein said controller measures a parameter of at least one of said plurality of channels, and wherein said controller determines an availability of at least one channel of said plurality of channels, and communicates said availability to at least one of said plurality of transceivers to transmit and receive the communication signal.

13. The communication system of claim 12, wherein said channel selector changes a current channel of at least one of said plurality of transceivers to said available channel.

14. The communication system of claim 13, wherein said controller configured to remove said amount of noise from said far communication signal by removing a modulating local communication component of said communication signal.

15. The communication system of claim 14, wherein said modulating local communication component of said communication signal is attributed from at least one of said plurality of transceivers.

16. The communication system of claim 12, wherein at least some of said plurality of local transceivers form a first array and a second array, wherein said first array searches for an available channel, and wherein said second array transmits and receives signals on said available channel.

17. The communication system of claim 12, further comprising a trigger component, wherein said trigger component searches for said available channel, and said trigger component outputs a signal to said controller, said controller configured to control an array of said plurality of transceivers to receive the communication signal from the far communication system on said available channel.

18. A communication system receiving a communication signal from a far communication system, the communication system comprising:
a channel selector;
a plurality of local transceivers forming a first broadcast array and a second channel searching array, said first broadcast array being configured to receive said communication signal and transmit a local communication signal on a plurality of channels, wherein each of said plurality of local transceivers are connected to a controller, said controller configured to remove an amount of interference from said plurality of local transceivers being received on said channel;
wherein said controller measures a parameter of at least one of said plurality of channels, and wherein said controller determines an availability of at least one channel of said plurality of channels using said second channel searching array, and wherein said second channel searching array outputs an available channel signal to said controller, and said controller communicates said availability to at least one of said first broadcast array to transmit and/or receive the far communication signal on said available channel.

19. The system of claim 18, wherein said controller communicates said availability of said available channel to at least one of said first broadcast array wirelessly using another channel.

20. The system of claim 18, wherein said second channel searching array has said plurality of transceivers searching said plurality of channels during a predetermined time period, wherein each of said plurality of transceivers of said second channel searching array searches for a different amount of time relative to one another.

21. A transceiver comprising:
a generator connected to a transmit antenna;
a receive antenna connected to a receiver; and
a controller, wherein said controller is operatively connected to said generator and said receiver, said receiver receiving a plurality of signals on a wireless channel, said plurality of signals each being output to said controller, wherein said controller determines an availability of said wireless channel based in part on said plurality of signals, and wherein said controller changes said wireless channel to another available channel based on said determination.
